(19) United States
(12) Patent Application Publication
(10) Pub. No.: US 2013/0023607 A1
(43) Pub. Date: Jan. 24, 2013

(54) POLYMER ADDITIVE TO STRENGTHEN GUNNING COATINGS CONCRETE

(71) Applicant: Brilliant Coatings, Inc., Niagara Falls, NY (US)

(72) Inventor: James V. HODSON, Fruit Heights, UT (US)

(73) Assignee: BRILLIANT COATINGS, INC., Niagara Falls, NY (US)

(21) Appl. No.: 13/625,582

(22) Filed: Sep. 24, 2012

Related U.S. Application Data
(62) Division of application No. 12/872,217, filed on Aug. 31, 2010, now abandoned.

(51) Int. Cl. C04B 26/06

(52) U.S. Cl. 524/5

(57) ABSTRACT

This invention provides an additive for Portland Cement comprising a mixture of polyols, acrylic monomers and copolymers, wetting agent, polypropylene glycol and silicone.

### CROSS-REFERENCE TO RELATED APPLICATIONS

This application is a Divisional of application Ser. No. 12/872,217, filed on Aug. 31, 2010, which application is incorporated herein by reference in its entirety.

### FIELD OF THE INVENTION

This invention relates to a polymeric additive for cement that improves its compression and tensile strength. The invention has a preferred use for gunning coatings of cement.

### BACKGROUND OF THE INVENTION

Portland Cement is widely used for building construction and road construction. While a well-known and reliable material it has certain deficiencies, such as in strength and resistance to water. These deficiencies have been addressed by the utilization of polymers to improve these properties. U.S. Pat. No. 6,916,505 to Raymond et al., U.S. Pat. No. 6,548,589 to Widmer et al., and U.S. Pat. No. 6,387,176 to Widmer et al. are typical of patents related to the utilization of polymers in concrete. The polymers also may be coated onto the surface of cement.

Prior art gunnite includes the standard mix of Portland Cement mixed with sand, aggregate and water. The loose slurry is prepared by use of a standard transit mixer truck or device that will deliver a usable mixture of the above that can be applied by means of a high pressure sprayer applicator which is classified as a “Shot-crete” machine.

Further, an additive comprising an acrylic emulsion for reinforcing cement has been marketed by Hodson Laboratories has a composition of comprising a vinyl copolymer emulsion, and a vinyl acetate/acrylic copolymer of 1 part vinyl acetate and 3 parts acrylic polymer.

There remains a need for a polymer additive for cement to improve the strength and water resistance of the cement. There remains a need for an improved cement gunning material.

### SUMMARY OF THE INVENTION

The invention provides a polymer additive for Portland Cement comprising polyol, acrylic monomers and copolymers, wetting agent, propylene glycol and silicone. The cement is particularly suited for a concrete gunning process and to not be penetrated by water after curing.

### DETAILED DESCRIPTION OF THE INVENTION

The additive of the invention has numerous advantages in gunning cement over prior materials for adding to a cement, such as Portland Cement. The invention material improves compression and tensile strength. The cohesive strength of the cement is also improved. Further the invention cement additive materials are stable at sub-freezing temperatures prior to use. The invention additive is relatively low in cost and easily mixed with the cement prior to utilization. The invention provides improved gunned cement. These and other advantages of the invention will be clear from the detailed description below.

In a preferred form of the invention the chemical additive composition of the invention consists of the following: mixture of polyols, acrylic monomers, and copolymers modified with organic propylene glycols, wetting agents consisting of nonyl-octal-phenolic ethylene oxide condensates, blended with a silicone fluid and emulsified with propylene glycol component. The intended use for the composition is to modify gunned Portland Cement concrete imparting the following characteristics: increased compressive strength over a conventional cement, increased tensile strength, and increased flexural strength. The durability of the cement composition is enhanced as water resistance is increased, thus preventing freeze-thaw-degradation from taking place.

The gunning cement additive of the invention may be utilized in both new construction, in mines, and in mending or repairing older construction. It may be used in mines and repairing bridge supports. The cements formed with additive of the invention find a preferred use in gunning of cement to reinforce structures such as the roofs of mines or tunnels.

Any suitable polyol may be used for the gunning compositions of the invention. Suitable polyols are ethylene glycol, propylene glycol, and Tricresyl phosphate. The preferred material is 2,2,4-trimethyl-1,3-pentanedoil monoisobutyrate polyol as this polyol leads to the good flexibility and strength when the material is gunned in a mine and cured.

The acrylic monomers may have any suitable molecular weight. A suitable molecular weight is between 79 and 200 as determined by the weight average method.

The acrylic copolymers may be any suitable acrylic copolymers. Typical of acrylic copolymers suitable for the invention are vinyl copolymers with vinyl/acrylic copolymer emulsion. A preferred copolymer is a vinyl acetate/acrylic copolymer in a ratio of 1 part by weight vinyl acetate to 3 parts acrylic because it provides good strength and water resistance.

The wetting agent utilized for the invention may be any suitable wetting agent that will aid in disbursing the ingredients. Typical of suitable wetting agents are non-ionic ethylene oxide condensates. A preferred wetting agent is a non-ionic ethylene oxide condensate because non-ionic is preferred so that any undesired chemical reactions will not occur in the additive materix. Another preferred wetting agent is silicone fluid because silicone fluid acts as a defoaming agent thus allowing for the removal of most of the entrapped air in the cement mix design. This increases the physical properties such as: (1) compressive strength, (2) flexural strength, and (3) tensile strength. It is also preferred to use a combination of ethylene oxide condensate and silicone fluid for the same reasons is listed above for the individual materials. A most preferred embodiment is the use of n-octal-phenolic ethylene oxide condensates blended with silicone fluid and emulsified with the polypropylene glycol component because octyl-nonyl phenolic ethylene oxide condensate blended with silicone fluid and emulsified with propylene glycol improved flexibility and water resistance. Propylene glycol acts as a safe diluent and has the desired solubility factor to carry the silicone fluid and the wetting agent into the acrylic polymer/copolymer without phase separation. Another advantage of the use of the polypropylene glycol is that it lowers the freezing point of the invention cement additive and makes storage of the additive cheaper and easier.

The acrylic polymers and copolymers generally comprise any suitable amount of the additive that results in an improved Portland Cement. Generally, there are present in an amount of between 75 and 90 weight percent of the total additive of the invention because this provides enough acrylic polymer to ensure that the additive will be of a sufficient percentage to provide for micro encapsulation of the cement and aggregate particles.

The silicone fluid may be present in any suitable amount in the additive. Generally, an amount of between one and three weight percent of the total cement additive is suitable. The silicone fluid generally has a viscosity of between about 10 and 100 pps. A preferred range of viscosity is between 30 and 90 pps. The most preferred silicone fluid viscosity range is between 40 and 60 pps as this provides an improved reduction in oxygen from the cement and also improves the cement's resistance to moisture.

The propylene glycol generally is present in between about 5 and 15 weight percent of the total weight of the additive of the invention.

The invention provides a method of forming a strengthened gunned Portland Cement comprising mixing 6 to 30 parts by weight Portland cement with between one to three parts by weight of the invention cement additive. The cement additive of the invention comprises a mixture of polyol, acrylic monomers and copolymers, wetting agent, propylene glycol, and silicone.

Any type of Portland Cement may be utilized in invention. Portland cements generally comes in Type 1, Type 2 and Type 3 and the use of a different type is dependent on availability, commercial needs and type of transport, as Type III may be air transported. Generally, polymer reinforced Portland cement, of the prior art, have a tensile strength of between 300 and 500 psi. Cements made with the additive of the invention may have the tensile strength of between 1500 and 1800 psi. The flexural strength of the cements made utilizing the invention additive are about 2100 psi. Whereas the typical polymer reinforced Portland cement has a flexural strength of between 1400 and 1800 psi. The compressive strength of the invention additive reinforced cement is about 8,500 psi to fracture. The typical reinforced Portland cement now available has a strength of between 2400 and 5,500 psi to fracture. Therefore it is clear that the properties of the Portland cement, formed using the polymer additive of the invention, are extremely desirable.

In a mine or tunnel, a coating is applied using a conventional gunnite machine to a thickness of three inches for the initial coat and an additional coat is applied at a thickness of three inches. A total of six inches is applied to provide for a coat that will give flexural strengths in the 2100 psi. The tensile strengths is in the 1500-1800 psi range. The initial set time of the material is four hours. Total cure is approximately 28 days.

The amount of cement, aggregate, cement additive of the invention, and water will be varied depending on the use intended for the gunned cement. The cement for use in gunning in a mine would have a composition, in parts by weight of about 1 part water, 4 parts invention polymer additive, 9 parts Type II Portland Cement, and 15 parts aggregate. A composition for use in repairing a bridge support would comprise in parts by weight about 1 part water, 3 parts additive composition of the invention, 8 parts Portland cement (Type II), and 8 parts aggregate. The weight ratio of Portland cement to the additive of the invention generally is between 9:4 and 3:1. Generally, a preferred amount is between 4 and 5 parts by weight cement to 1 part by weight of the additive of the invention for the formation of a strong and waterproof cement without utilizing a great amount of the more expensive additive.

### EXAMPLE 1

An acrylic monomer Roplex 1834 an acrylate polymer free of ammoniated additives which makes the polymer safe for use with Portland Cement in an amount of 36 kilograms and Roplex 1834 an acrylic copolymer of acrylate and vinyl 12 kilograms in 1:3 ratio are blended together in a steel vessel for a period of 30 minutes. 2,2,4-trimethyl-1,3-pentanediol monoisobutyrate polyol, in an amount of 2 kilograms, propylene glycol in an amount of 2 kilograms. Triton X 100 an alkylaryl polyether alcohol wetting agent in an amount of 2 kilograms, and a silicone fluid in an amount of 2 kilograms with a viscosity of about 50 cps are blended together in a separate vessel for a period of 30 minutes. The propylene glycol, wetting agent, and the silicone fluid are blended and then introduced to the acryilic monomer/copolymer and the entire solution is blended for 30 minutes to form the polymer additive. 3.5 kilograms of the polymer additive solution is then blended with a mixture of 10 kilograms of the Portland Type I and 25 kilograms of cement sand. All mixing temperatures are at about 20.degree. C. The cement has a consistency suitable for gunning and, after curing, has a tensile strength of about 1500 psi and a flexural strength of about 2100 psi. The tensile strength is determined by ASTM test C 190-72. The flexural strength is determined by ASTM C 348-72.

### EXAMPLE 2

### Comparison Example

A vinyl/acrylic copolymer binder Rovace 661 is a copolymer of acrylic comprising polybutyl acetate and vinyl polymer comprising vinyl acrylic. The ratio of polymer and water in Rovace 661 is 55% polymers and 45% water and blended with 48 kilograms blended with 2 kilograms Triton X 100 that has been diluted with 2 kilograms of propylene glycol and 2 kilograms 5% silicone fluid that has a viscosity of 50 CTS and is blended in a polyethylene container for 30 minutes. The product is then ready to be used in a Portland Cement mix design.

This prior art polymer blend is used at a ratio of 10 lbs. per bag (94 pounds) or Portland Cement to make a concrete that has good bonding strength but has less strength than the composition of Example 1 above. The prior art material of Example 2 has a tensile strength (PSI) after 28-day air cure of 325 PSI and a flexural strength (PSI) after 28-day air cure of 770 PSI.

1-12. (canceled)

13. A method of forming a strengthened Portland cement comprising mixing 6 to 20 parts by weight Portland cement with between 1 to 3 parts by weight of a polymer additive for Portland cement comprising polyol, acrylic monomers and copolymers, wetting agent, propylene glycol and silicone, and water as needed to form a cement mixture, and gunning the mixture.

14. The method of claim 13 wherein the Portland cement is Type I or Type II Portland cement.

15. The method of claim 13 wherein the acrylic monomers have molecular weight of between 79 and 200 as determined by weight average method.

16. The method of claim 13 wherein said copolymers comprises copolymers of acrylic polymer/vinyl acrylic copolymer emulsion.

17. The method of claim 13 wherein the acrylic copolymers comprise at least one member selected from the group consisting vinyl, ethylene, and propylene.

18. The method of claim 13 wherein the wetting agent comprises a phenolic ethylene oxide condensate.

19. The method of claim 13 wherein the wetting agent comprises silicone fluid.

20. The method of claim 13 wherein the acrylic polymers and copolymers comprise between 75 and 90 weight percent of the additive.

21. The method of claim 13 wherein the silicone fluid comprises between 1 and 3 weight percent of the cement additive.

22. The method of claim 13 wherein the propylene glycol comprises between 5 and 15 weight percent of the cement additive.

23. The method of claim 13 wherein the polyol gunning additive is selected from ethylene glycol, propylene glycol, polypropylene glycol, tricresyl phosphate and 2,2,4-trimethyl-1,3-pentanediol monoisobutyrate.

24. The method of claim 13 wherein the polyol comprises 2,2,4-trimethyl-1,3-pentanediol monoisobutyrate polyol.

25. A cement composition comprising Portland cement and a polymer gunning strengthening additive for Portland cement comprising polyol, acrylic monomers and copolymers, wetting agent, propylene glycol and silicone.

26. The composition of claim 25 wherein said composition has a flexural strength in the range of 1400-1800 psi.

27. The composition of claim 25 wherein said composition has a tensile strength of greater than 1500 psi.

28. The composition of claim 25 wherein the polyol gunning additive is selected from ethylene glycol, propylene glycol, polypropylene glycol,

29. The composition of claim 25 wherein the polyol comprises 2,2,4-trimethyl-1,3-pentanediol monoisobutyrate polyol.
